(19) United States
(12) Patent Application Publication
(10) Pub. No.: US 2004/0247254 A1
(43) Pub. Date: Dec. 9, 2004

(54) Ferrule molding die and ferrule

(76) Inventors: Setsuo Shouji, Chiba (JP); Masahiko Tsunemi, Chiba (JP); Tarou Ueno, Chiba (JP); Hidekazu Morito, Chiba (JP); Masaru Aikawa, Chiba (JP); Junji Taira, Chiba (JP)

Correspondence Address: Bruce L Adams, Adams & Wilks, 31st Floor, 50 Broadway, New York, NY, 10004, US

(21) Appl. No.: 10/486,158

(22) PCT Filed: Aug. 22, 2001
(86) PCT No.: PCT/JP01/07190

(51) Int. Cl. G02B 6/36

(52) U.S. Cl. 385/78

(57) ABSTRACT

There is provided a core pin for injection molding of a ferrule accompanied by a small amount of wear by forming a core pin constituted by a circular cylinder portion having a first diameter at a portion thereof for forming one end face of the ferrule and having a first angle of inclination by which a diameter thereof is enlarged toward other end thereof, a circular cone portion having a second diameter larger than the first diameter at a portion thereof for forming other end of the ferrule and having a second angle of inclination an angle of which is larger than the first angle of inclination by which a diameter thereof is reduced toward the one end face and a curved face in contact with the circular cylinder portion and the circular cone portion and having a section in a circular arc shape.

### TECHNICAL FIELD

The present invention relates to a ferrule constituting a part of an optical fiber connector used in connecting an optical fiber, particularly relates to a die for a ferrule produced by injection molding of ceramic and a ferrule.

### BACKGROUND OF THE INVENTION

Conventionally, in injection molding of a ferrule of partially stabilized zirconia, in order to form a small diameter hole of a ferrule, there is used a core pin of a straight type having a uniform diameter in a length direction of the ferrule. Further, after injection molding, sintering is carried out and inside of the small diameter hole is polished by a wire over a total of the ferrule in an axial direction to thereby finish the small diameter hole having an inner diameter of 125 micrometers.

However, when the injection molding of the ferrule is carried out by using the conventional core pin, since the core pin is not provided with draft taper, frictional resistance in drawing the core pin is considerable and there poses a problem that wear of the core pin is caused. By the wear of the core pin, there is a drawback that dimensional accuracy of the ferrule is deteriorated such that the small diameter hole is eccentric to an outer diameter of the ferrule, roundness of the small diameter hole is reduced and so on and in connecting the optical fiber to the connector, there causes a deviation in an optical axis thereof and connection loss is increased.

Further, since there is not the draft taper, by flow of resin at a vicinity of a surface of the core pin in drawing the core pin, packing of ceramic powder becomes nonuniform, a shrinkage rate after sintering does not become constant and there poses a problem that an outer shape of the ferrule and the roundness of the small diameter hole are deteriorated. Further, there poses a problem that cracks are caused by entrapment of the resin at a vicinity of the core pin.

Further, since after sintering, the small diameter hole is polished over the total of the ferrule in the axial direction, an amount of polishing zirconia ceramic is large and as a result, there poses a problem that a considerable time period is taken in polishing the inner diameter of the small diameter hole, the wire for polishing is worn fast and the like.

### DISCLOSURE OF THE INVENTION

According to the invention of the application, there is used a tapered core pin comprising a circular cylinder portion having a first diameter at one end face of a ferrule and having a first angle of inclination enlarging a diameter thereof toward other end thereof, a circular cone portion having a second diameter larger than the first diameter at the other end of the ferrule and having a second angle of inclination by which a diameter thereof is reduced toward the one end face and an angle of which is larger than the first angle of inclination and a curved face portion in contact with the circular cylinder portion and the circular cone portion therebetween and having a section in a circular arc shape.

Further, according to the invention of the application, there is produced a ferrule by forming a ferrule molding material having a hole in a tapered shape having an inner diameter smaller than an outer diameter of an optical fiber strand at one end face thereof and having an inner diameter larger than the outer diameter of the optical fiber strand toward other end thereof and on an inner side of the other end and thereafter polishing the hole by a wire.

According to the invention of the application, there is used a tapered core pin comprising a circular cylinder portion having a first diameter at one end face of a ferrule and having a first angle of inclination enlarging a diameter thereof toward other end thereof, a circular cone portion having a second diameter larger than the first diameter at other end of the ferrule and having a second angle of inclination by which a diameter thereof is reduced toward the one end face and an angle of which is larger than the first angle of inclination and a curved face portion in contact with the circular cylinder portion and the circular cone portion therebetween and having a section in a circular arc shape.

In this case, it is possible to provide a straight portion without having an angle of inclination at a portion of the circular cylinder portion for forming the end face of the ferrule. In this case, the first angle of inclination is preferably 0.3 through 0.4°. Further, a length of the circular cylinder portion is preferably 60 through 90% of a length of a total of the ferrule and more preferably 75 through 85% thereof.

Further, a radius of curvature of the curved face portion is preferably 0.3 mm through 0.5 mm.

Further, there may be provided a second circular cylinder portion having a third angle of inclination larger than the first angle of inclination and smaller than the second angle of inclination between the circular cylinder portion and the curved face portion. In this case, the first angle of inclination is preferably 0.07 through 0.09°. In this case, a length of the circular cylinder portion is preferably 90 through 120% of a total length of the ferrule and more preferably 95 through 110% thereof.

Further, according to the invention of the application, there is produced a ferrule by forming a ferrule molding material having a hole in a tapered shape having a inner diameter smaller than an outer diameter of an optical fiber strand at one end face thereof and having an inner diameter larger than the outer diameter of the optical fiber strand toward other end thereof and on an inner side of the other end and thereafter polishing the hole by a wire. In this case, an inner diameter of the one end face is preferably 95 through 105 micrometers and more preferably, 99 through 103 micrometers.

### BRIEF DESCRIPTION OF THE DRAWINGS

FIG. 1 is a sectional view showing a core pin according to the invention,

FIG. 2 is a sectional view showing a ferrule molding material according to the invention,

FIG. 3 is a sectional view showing polishing of the ferrule according to the invention,

FIG. 4 is a sectional view showing other embodiment of a core pin according to the invention and

FIG. 5 is a sectional view showing other embodiment of a ferrule molding material according to the invention.

### BEST MODE FOR CARRYING OUT THE INVENTION

In order to understand the invention in further details, an explanation will be given thereof in reference to the attached drawings.

(Embodiment 1)

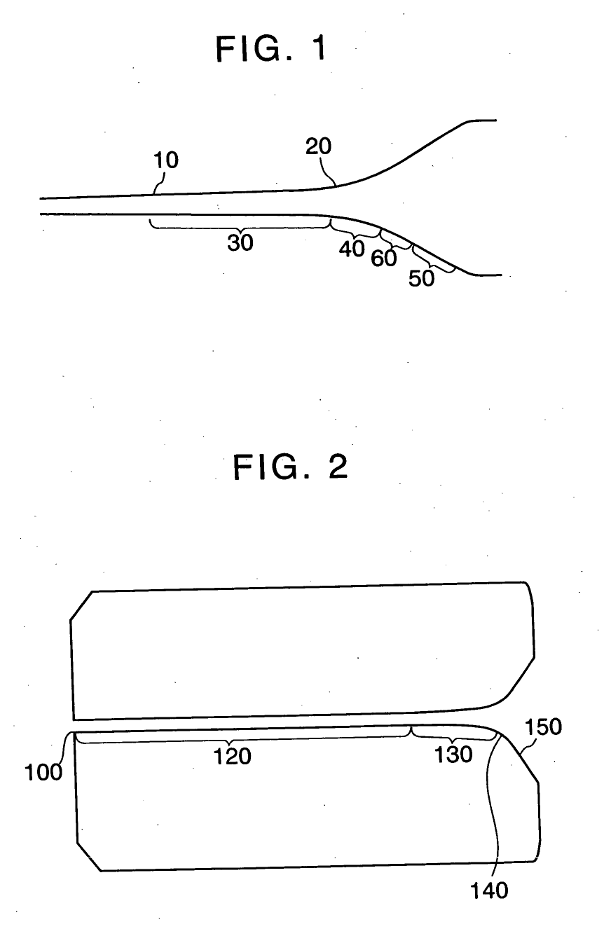

FIG. 1 shows a sectional view of a core pin according to the invention. There is provided a first taper portion 30 having a first neck portion 10 having a wire diameter of 137 micrometers at a position coinciding with one end face of a ferrule and a second neck portion 20 of 168 micrometers at a position apart from the first neck portion by 11 millimeters in a root direction in injection molding. An angle of inclination of the first taper portion is 0.08°. Further, there is provided a second taper portion having a diameter enlarged from the second neck portion 20 further in the root direction. An angle of inclination of the second taper portion is larger than the angle of inclination of the first taper portion.

Further, there is provided a third taper portion 50 which is provided with an angle of 60° in symmetry with an axis of the core pin and a diameter of which is enlarged toward other end of the ferrule, at a position coinciding with other end of the ferrule in injection molding. Further, there is arranged a curved face portion 60 having a section in a shape of a circular arc for smoothly connecting the second taper and the third taper between the second taper portion and the third taper portion.

FIG. 2 shows a ferrule molding material provided by subjecting zirconia ceramic mixed with a binder to injection molding by using the core pin of FIG. 1 and sintering the ceramic. There is formed a first hole portion 120 having an opening portion 100 having an inner diameter of 102 micrometers at one end face thereof and a neck portion 110 having an inner diameter of 125 micrometers at a position deviated from the end face to other end thereof by 8.227 millimeters. Successively, there are formed a second hole portion 130 having an angle of inclination larger than that of the first hole portion, a curved face portion 140 and a circular conical face portion 150 having an angle of 60°.

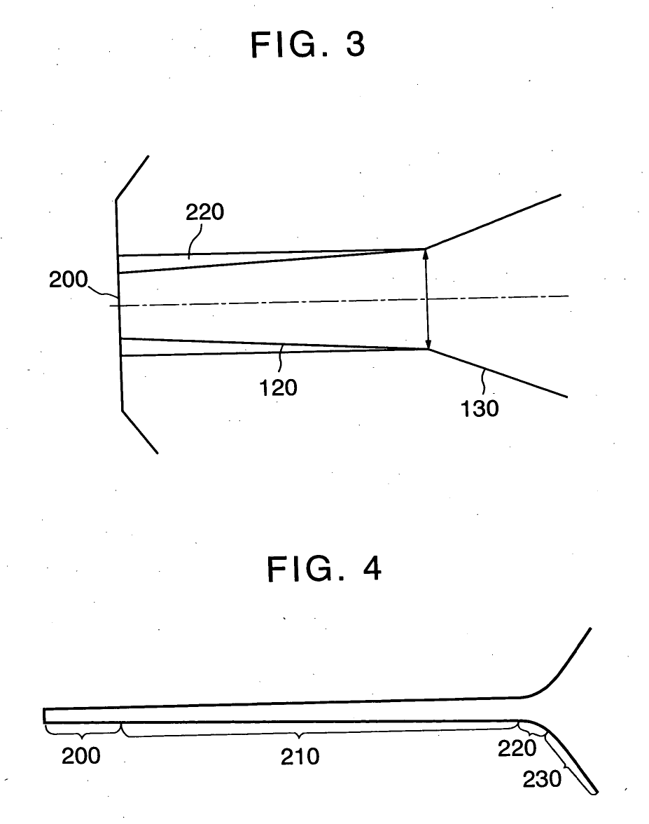

FIG. 3 shows a sectional view of a front end portion of the ferrule molding material. There is formed a first hole portion in which a front end thereof is provided with an opening portion 200 having an inner diameter of 102 micrometers, and other end side thereof deviated by 8.227 micrometers therefrom, is provided with an inner diameter of 125 micrometers and an inner face of the hole is polished by a wire and diamond abrasive grains to thereby polish and remove a portion 220 to be polished. In this case, the portion 220 to be polished is a circular cylinder having a slanted section, an amount of polishing therefore becomes a half of that of the conventional example, what is called hole polishing time period is halved and a working time period can be shortened. Further, the first hole portion constitutes a reference face of contact of the wire, a center of a hole produced by polishing is not shifted from a center of the hole of the molding material and there is provided a product having high roundness of a hole of a final product.

A ferrule polished as described above, is provided with a shape constituted by the first hole portion having a length of 8.227 mm and the inner diameter of 125 micrometers from its end face, the first taper portion, the curved face portion and the second taper portion successive thereto.

(Embodiment 2)

FIG. 4 shows a view of an end face of other embodiment of a core pin according to the invention of the application. The embodiment is constituted by two tapers by making the front end portion of the core pin of Embodiment 1 straight and dispensing with the second taper portion.

In FIG. 4, there is arranged a circular cylinder portion 200 having a uniform outer diameter with no taper at a front end portion of the core pin. In this case, the outer diameter is 132 micrometers. Successively, there is provided a first taper portion 210 connected to the circular cylinder portion 200. An inclination of the taper portion is 0.339° and a length thereof is 8.291 mm. Successive thereto, there are provided a curved face portion 220 for smoothly connecting thereto and a second taper portion 230 having an angle of 60° successive thereto.

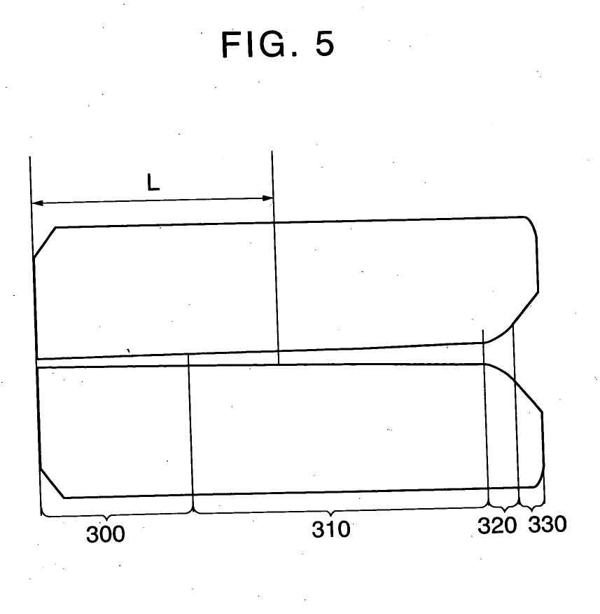

FIG. 5 shows a sectional view of a ferrule molding material produced by subjecting zirconia ceramic to injection molding by using the above-described core pin and sintering the ceramic. The material is constituted by a first hole portion 300 constituting a straight portion with no taper from a front end thereof, a second hole portion 310 having a taper, a curved portion 320 constituting a gradual connecting face and a third hole portion 330 having a taper in contact with other end thereof successive thereto. In this case, an inner diameter of a front end of the first hole portion 300 is 100 micrometers. Further, a distance L from the end face to a position at which an inner diameter of the second hole portion becomes 125 micrometers, is from 3.1 to 6 mm.

By polishing the above-described molding material by a wire, a length thereof from the front end equal to the distance L is polished to thereby provide a ferrule having the hole portion with no taper, the first taper portion having the taper, the curved face portion and the second taper portion successive to the hole portion.

### INDUSTRIAL APPLICABILITY

As described above, according to the invention of the application, a core pin having a taper is used and therefore, by polishing a portion of a length of a ferrule molding material, a final shape of a ferrule can be provided and therefore, there is achieved an excellent effect capable of shortening a working time period, reducing eccentricity of a hole at inside of the ferrule and providing the ferrule having small connection loss.

1. A ferrule molding die comprising:
a first circular cylinder portion having a first diameter at a portion of forming one end face of a ferrule and a first angle of inclination by which a diameter thereof is enlarged toward other end thereof;
a circular cone portion having a second diameter larger than the first diameter at a portion of forming other end of the ferrule and having a second angle of inclination an angle of which is larger than the first angle of inclination; and
a curved face portion in contact with the circular cylinder portion and the circular cone portion therebetween and having a section in a circular arc shape.

2. The ferrule molding die according to claim 1, further comprising a second circular cylinder portion an angle of inclination of which is larger than the first angle of inclination and smaller than the second angle of inclination between the circular cylinder portion and the circular cone portion.

3. A ferrule molding material having a hole in a tapered shape having an inner diameter smaller than an outer diameter of an optical fiber strand at one end face thereof and having an inner diameter larger than the outer diameter of the optical fiber strand toward other end thereof and on an inner side of the other end.

4. A method of producing a ferrule by forming a ferrule molding material having a hole in a tapered shape having an inner diameter smaller than an outer diameter of an optical fiber strand at one end face thereof and having an inner diameter larger than the outer diameter of the optical fiber strand toward other end thereof and on an inner side of the other end and thereafter polishing the hole by a wire.

5. A ferrule comprising, from one end face thereof, a first hole portion having a same inner diameter, a first taper portion which is connected to the first hole portion and a diameter of which is enlarged toward other end thereof, a curved face portion smoothly connected to the first taper portion and a second taper portion which is connected to the curved face portion and a diameter of which is enlarged toward the other end.

6. The ferrule according to claim 5, further comprising a third taper portion between the first taper portion and the curved face portion.
